(19) United States
(12) Patent Application Publication
(10) Pub. No.: US 2005/0214099 A1
(43) Pub. Date: Sep. 29, 2005

(54) Fastener for use in securing side rails to round-hole and square-hole mounting rails of cabinet racks

(75) Inventors: Melissa Silvestro, Uxbridge, MA (US); Joseph P. King JR., Sterling, MA (US); Joseph P. DeYesso, Walpole, MA (US); Albert F. Beinor JR., Sutton, MA (US); Lawrence J. Feroli, W. Townsend, MA (US); Joseph L. Brigham JR., North Attleboro, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: EMC Corporation, Hopkinton, MA (US)

(21) Appl. No.: 10/812,266

(22) Filed: Mar. 29, 2004

(51) Int. Cl. B60R 9/00

(52) U.S. Cl. 411/424

(57) ABSTRACT

Described is a fastener that includes a shank having a thread, a head, and a stepped portion situated between the head and the threaded portion. The stepped portion has a diameter that is larger than the diameter of a round hole in a first type of mounting rail and smaller than a length of a side of a square hole in a second type of mounting rail. When the fastener is inserted into a round hole, the stepped portion is urged against a front surface of the mounting rail. When the fastener is inserted into a square hole, the stepped portion enters closely into the square hole and the head portion is urged against the mounting rail. Accordingly, the fastener can be used with either of two types of mounting rails: Universal Mounting Rails and EIA Standard Mounting Rails.

### FIELD OF THE INVENTION

The invention relates generally to fasteners. More particularly, the invention relates to a fastener for securing side rails to round-hole and square-hole mounting rails of cabinet racks.

### BACKGROUND

Electronic equipment is often housed in a metal framework called an equipment rack. Usually, an equipment rack contains multiple bays. Each bay holds a unit of equipment, such as a server or a switch. Racks are generally available in standard sizes. Common sizes include 19″ racks and 23″ racks. These dimensions correspond to the width of the rack; the height and depth of the racks can vary. Typically, each unit of equipment occupies one of the bays and is secured to the rack with screws. To install a unit of equipment in a four-post rack, for example, a side rail is secured to each side of the unit of equipment. This equipment assembly is then attached to the front and back vertical structural members of the rack, herein referred to as mounting rails.

The National Electrical Manufacturers Association (NEMA) has defined standards for cabinet racks. The standards provide definitions for the construction, dimensions, and tolerances of such cabinet racks and of the mounting rails within a cabinet rack. Standardized types of mounting rails include: 1) Universal Mounting Rails, which have square holes and 2) Electronics Industry Association (EIA) Standard Mounting Rails, which have round 0.280 inch holes. The type of hardware used to attach side rails to mounting rails depends upon the particular type of mounting rail used in the cabinet rack. For Universal Mounting Rails, flat head screws, cone washers and tapped cage nuts are commonly used. For EIA Standard Mounting rails, screws and tapped cage nuts are used.

Suppliers of units of equipment may not know which type of mounting rails their customers are using, i.e., with round or with square holes. Consequently, kits for mounting side rails to a rack, to which the unit of equipment is to be attached, typically include hardware (i.e., fasteners) for both types. Providing both types of hardware ensures that the customer is able to secure the side rails to the type of rack on hand. Inevitably, however, one set of hardware remains unused, causing unnecessary manufacturing logistics and expense. There is, therefore, a need for a fastening means that works with both types of mounting rails.

### SUMMARY

In one aspect, the invention features a fastener comprising a shank having a thread, a head portion having a top surface, a planar bottom surface and a diameter, and a stepped portion situated between the head portion and the threaded portion. The stepped portion has a diameter that is larger than the diameter of a round hole in a first type of mounting rail and smaller than a length of a side of a square hole in a second type of mounting rail. When the fastener is inserted into one of the round holes of the first type of mounting rail, a bottom surface of the stepped portion is urged against a front surface of the first type of mounting rail. When the fastener is inserted into one of the square holes of the second type of mounting rail, the stepped portion enters closely into the square hole and the planar bottom surface of the head portion is urged against a front surface of the second type of mounting rail.

In another aspect, the invention features a fastener, comprising a shank having a thread, a head portion having a diameter, and a circular stepped portion between the head portion and the threaded portion, the stepped portion having a smaller diameter than the diameter of the head portion, the smaller diameter ranging between approximately 0.355 inches to approximately 0.365 inches.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1A is a top view of an embodiment of a fastener of the present invention.

FIG. 1B is a side view of the embodiment of the fastener of FIG. 1A.

FIG. 1C is an isometric view of the embodiment of the fastener of FIG. 1A.

FIG. 2A is an isometric view of an embodiment of a portion of a square-hole mounting rail.

FIG. 2B is a side view of a fastener of the invention inserted into one of the square holes in the square-hole mounting rail of FIG. 2A.

FIG. 3A is an isometric view of an embodiment of a portion of a round-hole mounting rail.

FIG. 3B is a side view of a fastener of the invention inserted into one of the round holes in the round-hole mounting rail of FIG. 3A.

### DETAILED DESCRIPTION

The present invention features a versatile fastener capable of being used in cabinet racks to secure side rails to either type of NEMA mounting rail, i.e., to EIA Standard mounting rails with round holes or to Universal mounting rail with square holes. Providing a sufficient number of these fasteners in installation kits ensures that the installer will be able to secure the side rails to the NEMA mounting rails, regardless of which type is employed in the cabinet rack.

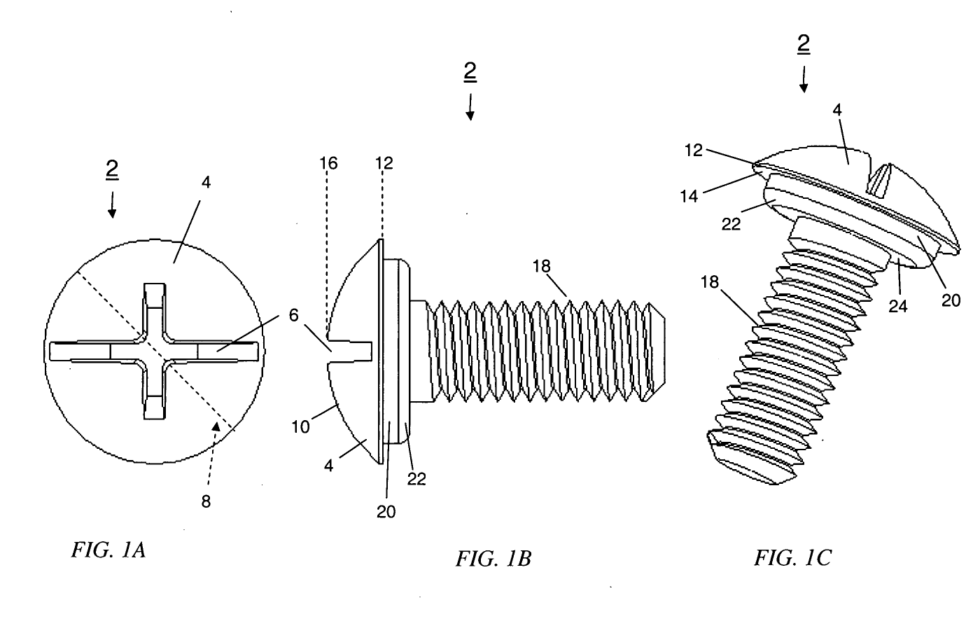

FIG. 1A shows an embodiment of a fastener 2 of the present invention from a top view. Materials for constructing the fastener 2 include metal and plastic. The fastener 2 has a round head 4 having a combination of a Phillips and slotted drive 6. Other embodiments of the fastener 2 have different drive mechanisms, examples of which include, but are not limited to, a slotted drive without the Phillips feature, a Phillips drive without the slotted feature, and a hexagonal hole (Allen). Preferably, a diameter 8 of the round head 4 ranges from 0.425 inches to 0.451 inches; although other diameters can be used without departing from the principles of the invention.

FIG. 1B and FIG. 1C show side views of the fastener 2 of FIG. 1A. The head 4 has a dome-shaped top surface 10, a round base 12, and a bottom surface 14 (FIG. 1C only). The head 4 can have other shapes (e.g., flat-head) without departing from the principles of the invention. In the embodiment shown, the dome-shape top surface 10 measures in a range of 0.103 inches to 0.118 inches from the dome apex 16 to the round base 12.

The fastener 2 also includes a shank 18 and a stepped portion 20 with a tapered shoulder 22. In one embodiment, the shank 18 includes an M5 by 0.8 inch thread. Situated between the shank 18 and the head 4, the stepped portion 20 is adjacent the base 12 of the head 4. The stepped portion 20 is generally circular in shape (i.e., a cylindrical volume with a circular periphery) and has a bottom surface 24 (FIG. 1C only). In one embodiment, a thickness of the stepped portion 20, measured from the base 12 of the head 4 to the bottom surface 24, is 0.055 inches with 0.005 inch plus or minus tolerances.

The diameter of the stepped portion 20 is larger than the diameter of the shank 18 and smaller than the diameter 8 of the head 4. In one embodiment, this diameter of the stepped portion is approximately 0.360 inches, and manufacturing tolerances for the diameter are plus or minus 0.005 inches. These particular dimensions and tolerances ensure that the stepped portion 20 of each fastener 2 fits closely into a square hole of a Universal Mounting Rail. According to the NEMA standard for the Universal Mounting Rail, each side of a square hole is specified at 0.375 inches with plus or minus 0.005 inch tolerance. Accordingly, the largest permissible stepped portion diameter, i.e., 0.365 inches, is smaller than the smallest permissible side dimension of a square hole, i.e., 0.370 inches. The tapered shoulder 22 can guide the stepped portion 20 into the square hole. The close fit ensures that the stepped portion 20 is centered in the square hole. This close fit can also be achieved without the use of a washer. Also, the circular shape of the stepped portion 20 permits the fastener 2 to be rotated within the square hole for tightening to a threaded nut (for example) located on the opposite side of the mounting rail.

The dimensions and tolerances of the diameter of the step portion 20 are also larger than the diameter of the round holes of the EIA Standard Mounting Rails. According to the NEMA standard for EIA Standard Mounting Rails, the diameter of the circular hole is specified at 0.280 inches with a plus or minus 0.004 inch tolerance (7.1 mm ±0.1 mm). The NEMA standard referred to is EIA Standard EIA-610-D Cabinets, Racks, Panels and Associated Equipment. Accordingly, the smallest permissible stepped portion diameter, i.e., 0.355 inches, is larger than the largest possible circular hole.

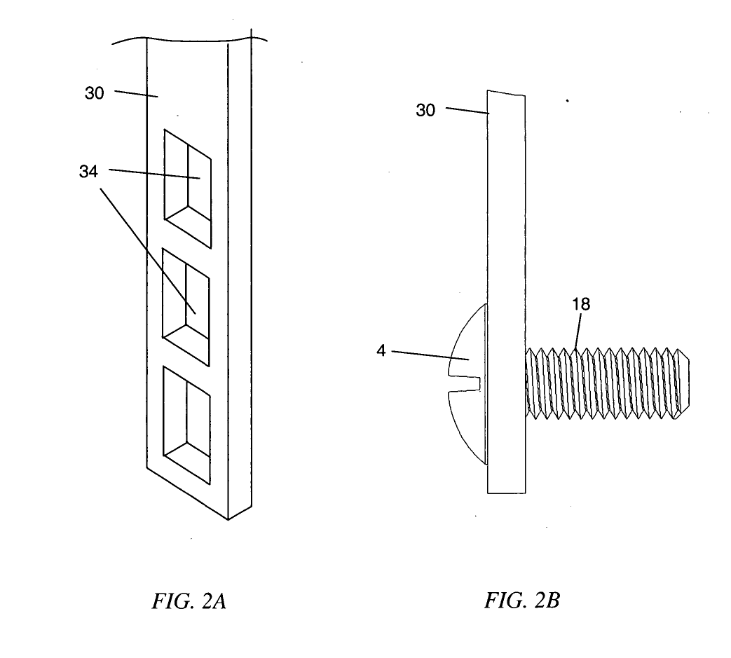

In brief overview, when the fastener 2 is used to attach, for example, a side rail, a unit of equipment, or a front-panel catch to a Universal Mounting Rail with square holes, the stepped portion 20 enters the square hole fully such that the bottom surface 14 of the head 4 abuts the mounting rail. FIG. 2A shows a portion of a mounting rail 30 having a plurality of square holes 34, and FIG. 2B illustrates an example of one fastener 2 that is inserted through one of the square holes 34.

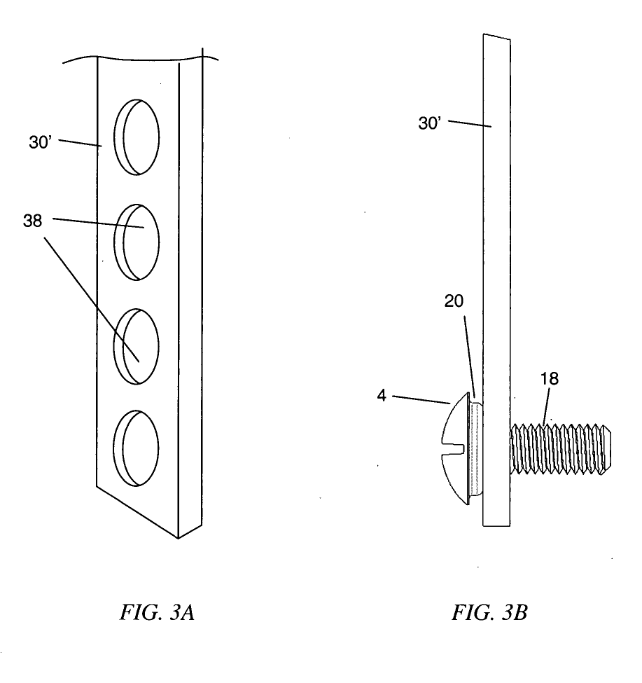

When the fastener 2 is used for attaching to an EIA Standard Mounting Rail with round holes, the shank 18 penetrates the round hole up to the bottom surface 24 of the stepped portion 20. FIG. 3A shows a portion of a mounting rail 30′ having a plurality of round holes 38, and FIG. 3B illustrates an example of one fastener 2 that is inserted through one of the round holes 38 such that the bottom surface 24 of the stepped portion 20 abuts the mounting rail.

Although the invention has been shown and described with reference to specific preferred embodiments, it should be understood by those skilled in the art that various changes in form and detail may be made therein without departing from the spirit and scope of the invention as defined by the following claims.

1. A fastener, comprising:
a shank having a threaded portion;
a head portion having a top surface, a planar bottom surface, and a diameter; and
a stepped portion between the head portion and the threaded portion, the stepped portion having a diameter that is larger than the diameter of a round hole in a first type of mounting rail and smaller than a length of a side of a square hole in a second type of mounting rail, wherein when the fastener is inserted into one of the round holes of the first type of mounting rail a bottom surface of the stepped portion is urged against a front surface of the first type of mounting rail, and when the fastener is inserted into one of the square holes of the second type of mounting rail the stepped portion enters closely into the square hole and the planar bottom surface of the head portion is urged against a front surface of the second type of mounting rail.

2. A fastener, comprising:
a shank having a threaded portion;
a head portion having a top surface, a planar bottom surface, and a diameter; and
a stepped portion between the head portion and the threaded portion, the stepped portion being circular in shape and having a diameter that is larger than the diameter of a round hole in a first type of mounting rail and smaller than a length of a side of a square hole in a second type of mounting rail, wherein when the fastener is inserted into one of the round holes of the first type of mounting rail a bottom surface of the stepped portion is urged against a front surface of the first type of mounting rail, and when the fastener is inserted into one of the square holes of the second type of mounting rail the stepped portion enters closely into the square hole and the planar bottom surface of the head portion is urged against a front surface of the second type of mounting rail.

3-8. (canceled)

9. A fastener, comprising:
a shank having a threaded portion;
a head portion having a diameter; and
a circular stepped portion between the head portion and the threaded portion, the stepped portion having a planar bottom surface perpendicular to the shank and a smaller diameter than the diameter of the head portion, the smaller diameter ranging between approximately 0.355 inches to approximately 0.365 inches so that the circular stepped portion is small enough to enter a square-hole of a Universal Mounting Rail and too large to enter a round hole, of an Electronics Industry Association Standard mounting rail.

10-16. (canceled)
